(19) United States
(12) Patent Application Publication
(10) Pub. No.: US 2019/0300760 A1
(43) Pub. Date: Oct. 3, 2019

(54) STRUCTURE ADHESIVE COMPOSITION WHICH CHANGES COLOR WHEN HEAT-CURED

(71) Applicants: CEMEDINE CO., LTD., Tokyo (JP); HONDA MOTOR CO., LTD., Tokyo (JP)

(72) Inventors: Daisuke MAKINO, Tokyo (JP); Atsuhiko SUZUKI, Tokyo (JP); Yuusuke MURACHI, Tokyo (JP); Katsutoshi ANDO, Saitama (JP)

(73) Assignees: CEMEDINE CO., LTD., Tokyo (JP); HONDA MOTOR CO., LTD., Tokyo (JP)

(21) Appl. No.: 16/315,868

(22) PCT Filed: Jul. 7, 2017
(86) PCT No.: PCT/JP2017/024960

§ 371 Date: Jan. 7, 2019

(30) Foreign Application Priority Data
Jul. 8, 2016 (JP) 2016-135992

(51) Int. Cl. C09J 11/06; C09J 163/00; C09J 5/06

(52) U.S. Cl. CPC C09J 11/06; C08K 5/23; C09J 5/06; C09J 163/00

(57) ABSTRACT

Provided are: a structure adhesive composition which changes color when heat-cured; a method for producing a vehicle structure using the same; and a vehicle structure. The structure adhesive composition which changes color when heat-cured is a structure adhesive composition including: (A) an epoxy resin; (B) an epoxy resin latent curing agent; and (C) a monoazo pigment, wherein a compounded proportion of the monoazo pigment in the structure adhesive composition constitutes 0.01-10 mass %. It is preferable for the structure adhesive composition to also contain (D) a curing accelerator.

### TECHNICAL FIELD

The present invention relates to a structure adhesive composition which changes color when heat-cured and is used for structural bonding of a body and parts of a vehicle to produce a vehicle structure.

### BACKGROUND ART

Conventional structure adhesive compositions used for joining body panels and parts of a vehicle to produce a vehicle structure are known.

Structure adhesive compositions are generally colored, and from the viewpoint of chemical stability, carbons such as carbon blacks and conductive carbons, titanium oxides, iron oxides, and the like are generally used (Patent Document 1). Because they are chemically stable, their colors are not changed by curing.

Determination of whether an adhesive that has bonded adherend portions constituting a structure of a vehicle is cured is generally made by preparing separate samples of the adhesive. That is, the samples are heated under conditions simulating a production line to determine whether the adhesive has been cured.

In a case where the heating is insufficient because of, for example, a malfunction in the vehicle production line, there is no choice but to cure and test the adhesive samples under the conditions based on a temperature record of a baking furnace, and the like, to determine whether the adhesive has been sufficiently cured. In addition, the determination is difficult because the heating status varies depending on sites of bonding.

### CITATION LIST

### Patent Literature

Patent Document 1: JP 2013-253131 A

### SUMMARY OF INVENTION

### Technical Problem

The present invention has been made in view of the problems of the known techniques, and aims to provide: a structure adhesive composition which changes color when heat-cured; a method for producing a vehicle structure using the same; and a vehicle structure.

### Solution to Problem

To resolve the problems, the structure adhesive composition according to an embodiment of the present invention is a structure adhesive composition which changes color when heat-cured, the composition including:

(A) an epoxy resin;

(B) an epoxy resin latent curing agent; and

(C) a monoazo pigment,

wherein a compounded proportion of the monoazo pigment in the structure adhesive composition is from 0.01 to 10 mass %.

A method for producing a vehicle structure according to an embodiment of the present invention includes:

coating the structure adhesive composition to an adherend; and

heat-curing the structure adhesive composition.

The structure adhesive composition according to an embodiment of the present invention is suitably used for the weld-bonding technique (a technique using an adhesive and spot welding in combination).

The vehicle structure according to an embodiment of the present invention is a vehicle structure produced by the method for producing a vehicle structure.

### Advantageous Effects of Invention

According to the present invention, the color of the adhesive changes when heat-cured, allowing remarkably advantageous effects of providing: a structure adhesive composition of which curing state can be visually determined; a method for producing a vehicle structure using the same; and a vehicle structure.

### DESCRIPTION OF EMBODIMENTS

Embodiments of the present invention will be described below; however, these embodiments are shown as examples, and it is needless to mention that various modifications are possible as long as such modifications do not deviate from the technical spirit of the present invention.

The structure adhesive composition according to an embodiment of the present invention which changes color when heat-cured is those including:

(A) an epoxy resin;

(B) an epoxy resin latent curing agent; and

(C) a monoazo pigment,

wherein a compounded proportion of the monoazo pigment in the structure adhesive composition is from 0.01 to 10 mass %.

For the epoxy resin used as the component (A), epoxy resins having an epoxy equivalent from 100 to 10000 can be used, and high molecular weight epoxy resins having an epoxy equivalent from 100 to 5000 are preferred.

For the epoxy resin, well-known epoxy resins are applicable. Examples thereof include: glycidyl ether substitution products of compounds of known basic skeletons such as bisphenol compounds, hydrogenated bisphenol compounds, phenol or o-cresol novolacs, aromatic amines, polycyclic aliphatic or aromatic compounds; compounds having a cyclohexene oxide skeleton, and the like. A representative compound thereof is exemplified by a diglycidyl ether of bisphenol A and its condensation product, i.e., the so-called bisphenol A type epoxy resin.

For the epoxy resin latent curing agent of the component (B), well-known epoxy resin latent curing agents are applicable. For example, latent curing agents for epoxy resins—the agents which are to be activated by heating—can be selected from a group of guanamines, guanidines, aminoguanidines, ureas, imidazoles, modified polyamines and derivatives thereof, dicyandiamide, a boron trifluoride amine complex, organic acid hydrazides, melamine, and the like. Among these, dicyandiamide, which is widely used, is preferred. Furthermore, the amount of the component (B) to be added is determined according to an epoxy equivalent of the matrix.

The proportion of the compounded epoxy resin latent curing agent (B) is not particularly limited but preferably is from 3 to 12 parts by mass, and more preferably from 8 to 12 parts by mass, per 100 parts by mass of the epoxy resin (A).

For the monoazo pigment of the component (C), well-known monoazo pigments are applicable. Examples thereof include: C.I. Pigment Yellow 1, C.I. Pigment Yellow 3, C.I. Pigment Yellow 5, C.I. Pigment Yellow 49, C.I. Pigment Yellow 65, C.I. Pigment Yellow 74, C.I. Pigment Yellow 97, C.I. Pigment Red 185, C.I. Pigment Red 213, C.I. Pigment Red 269, C.I. Pigment Red 146, C.I. Pigment Red 170, and C.I. Pigment Red 5.

The proportion of the compounded monoazo pigment (C) is from 0.01 to 10 mass %, and more preferably from 0.05 to 1 mass % in the structure adhesive composition.

It is preferable for the structure adhesive composition according to an embodiment of the present invention to contain (D) a curing accelerator. In a case where the structure adhesive composition contains (D) a curing accelerator, the curing activity of the latent curing agent in the structure adhesive composition is improved. Examples of such curing accelerators include: urea derivatives such as 3-phenyl-1,1-dimethylurea, 3-(3,4-dichlorophenyl)-1,1-dimethylurea (diuron), 3-(3-chloro-4-methylphenyl)-1,1-dimethylurea, and 2,4-bis(3,3-dimethylureido)toluene; imidazole derivatives; phosphorus-based compounds; tertiary amines; organic acid salts; Lewis acids; amine complex salts, and the like.

The use of the curing accelerator as described above allows the structure adhesive composition according to an embodiment of the present invention to be cured at a lower temperature than the usual curing temperature. For example, in a case where the structure adhesive composition according to an embodiment of the present invention contains dicyandiamide as the epoxy resin curing agent, curing of the structure adhesive composition usually requires applying heat approximately from 170 to 180° C. On the other hand, when the curing accelerator as described above is used, merely applying heat approximately from 80 to 150° C. enables curing. Furthermore, when dicyandiamide is used as the epoxy resin latent curing agent, 3-phenyl-1,1-dimethylurea and 3-(3,4-dichlorophenyl)-1,1-dimethylurea (diuron) are suitably used as the curing accelerator.

The proportion of the compounded curing accelerator (D) is not particularly limited but is preferably from 1 to 10 parts by mass, and more preferably from 1 to 5 parts by mass, per 100 parts by mass of the epoxy resin (A).

To the structure adhesive composition according to an embodiment of the present invention, a urethan resin, a filler, a diluent, a silane coupling agent, and the like may be added in addition to the components described above as long as the effect of the present invention is not impaired. Also, in addition to the components described above, an extender pigment (a filling material) such as calcium carbonate, barium sulfate, and talc can be added. Moreover, a thixotropic material such as silica, fine particle calcium carbonate, and sepiolite may be added. Still more, an acrylic resin can be also added as an adhesion improver to improve adhesiveness such as peel strength.

When heat-cured, the structure adhesive composition according to an embodiment of the present invention is decolorized and changed to white. For example, when Pigment Red 5 is used as the monoazo pigment, a structure adhesive composition that is red before heating is decolorized and changes to white when heat-cured. Because the color does not change in the uncured state even if the composition is heat-treated, the curing state can be visually determined.

The structure adhesive composition according to an embodiment of the present invention can be suitably used particularly as a one-part type.

The structure adhesive composition according to an embodiment of the present invention is used for structural bonding of parts such as a body of a vehicle and vehicle parts to produce a vehicle structure, and in particular, it is suitably used for bonding in a technique using spot welding and adhesive in combination (weld-bonding technique). That is, the structure adhesive composition of the present invention is also suitably used to bond a body of a vehicle.

The method for producing a vehicle structure according to an embodiment of the present invention is a method for producing a vehicle structure including steps of: coating the structure adhesive composition of the present invention to an adherend; and heat-curing the structure adhesive composition. Preferably, it is a method for producing a vehicle structure in a vehicle production line. Because the use of the structure adhesive composition of the present invention enables ascertaining the curing state of the adhesive by color change of the adhesive, curing of the adhesive can be easily determined even in a case where the baking is done in different conditions than usual because of a malfunction of the line.

Heating temperature in the step of heat-curing is not particularly limited as long as it is not lower than the temperature at which the structure adhesive composition of the present invention is allowed to be cured, but it is preferably from 140 to 220° C. and more preferably from 160 to 190° C.

### EXAMPLES

The present invention will be further specifically described below using examples; however, these examples are set forth to illustrate the present invention, and the scope of the present invention is not limited thereto.

### Example 1 and Comparative Example 1

Using parts by mass of each component shown in Table 1 below, structure adhesive compositions were produced according to the procedures described below. Each material was blended in a 5-L universal mixing stirrer (available from Dalton Corporation) and stirred for 30 minutes, and then defoamed under reduced pressure for 10 minutes to prepare the structure adhesive composition.

TABLE 1

| | | Comparative |
|---|---|---|
| | Example 1 | Example 1 |
| | mass % | mass % |
| (B) Epoxy resin latent curing agent*¹ | 4.7% | 4.7% |
| (D) Curing accelerator*² | 1.8% | 1.8% |
| Filler*³ | 6.1% | 6.1% |
| Filler*⁴ | 29.7% | 29.7% |
| Thixotropic material*⁵ | 3.0% | 3.0% |
| (A) Epoxy resin*⁶ | 54.5% | 54.5% |
| (C) Monoazo pigment*⁷ | 0.2% | — |
| Color pigment*⁸ | — | 0.2% |
| Total | 100.0% | 100.0% |

Materials in Table 1 are as follows.
*¹“DYHARD 100SH”, Dicyandiamide available from AlzChem Group AG
*²“EPICLON B605-IM”, Diuron available from DIC Corporation
*³“CCR”, Surface-treated calcium carbonate available from Shiraishi Kogyo Kaisha, Ltd.
*⁴“NN500”, Calcium carbonate available from Nitto Funka Kogyo K.K.
*⁵“TS-720”, Silica available from Cabot Japan K.K.
*⁶“DER331”, Bisphenol A type liquid epoxy resin available from Dow Chemical Japan Limited.
*⁷“ET5R108 Red”, A master batch of C.I. Pigment Red 5 available from Dainichiseika Color & Chemicals Mfg. Co., Ltd.
*⁸“SD2944 Brown”, A master batch of iron (II) oxide available from Nikko Bics Co., Ltd.

Each structure adhesive composition of Example 1 and Comparative Example 1 produced as described above was subjected to a performance test, and the results are shown in Table 2 below.

### (1) Shear Strength

The resulting structure adhesive composition was coated to a cold rolled steel sheet of 100 mm×25 mm×1.6 mm in a coating thickness of 0.1 mm. Two resulting steel sheets were overlapped in 12.5 mm, and the structure adhesive composition squeezed out therefrom were removed to make a test piece. The test piece was heat-cured under conditions of retaining it at 170° C. for 20 minutes, at 150° C. for 10 minutes, and at 100° C. for 20 minutes, and then allowed to stand to cool for 24 hours. Thereafter, the test was performed using a universal tensile tester at a tensile speed of 50 mm/minute. Those with a shear strength of not less than 20 MPa were evaluated as good and those less than 20 MPa were evaluated as poor.

### (2) Color Change

Colors of the adhesive composition before and after baking were visually compared. Adhesive compositions decolorized by baking from red to white were evaluated as passed and those unchanged were evaluated as failed.

TABLE 2

| | | | Comparative |
|---|---|---|---|
| | | Example 1 | Example 1 |
| Retained for baking | Shear strength [Mpa] | 27.3 | 27.1 |
| at 170° C. for 20 | Shear strength evaluation | Good | Good |
| minutes | Color change | Passed | Failed |
| Retained for baking | Shear strength [Mpa] | 26.4 | 26.2 |
| at 150° C. for 10 | Shear strength evaluation | Good | Good |
| minutes | Color change | Passed | Failed |
| Retained for baking | Shear strength [Mpa] | Not cured | Not cured |
| at 100° C. for 20 | Shear strength evaluation | Poor | Poor |
| minutes | Color change | Failed | Failed |

In Example 1, the color changed when the shear strength was good, while insufficient baking resulted in no change in color. On the other hand, in Comparative Example 1, no color change occurred by baking.

1. A structure adhesive composition which changes color when heat-cured, the composition comprising:
(A) an epoxy resin;
(B) an epoxy resin latent curing agent; and
(C) a monoazo pigment,
wherein a compounded proportion of the monoazo pigment in the structure adhesive composition is from 0.01 to 10 mass %.

2. The structure adhesive composition according to claim 1, further comprising:
(D) a curing accelerator.

3. A method for producing a vehicle structure, the method comprising:
coating the structure adhesive composition according to claim 1 to an adherend; and
heat-curing the structure adhesive composition.

4. A vehicle structure produced by the method according to claim 3.
